(19) United States
(12) Patent Application Publication
(10) Pub. No.: US 2014/0025740 A1
(43) Pub. Date: Jan. 23, 2014

(54) COLLABORATION ACTIVITY INITIATION

(71) Applicant: Aventura HQ, Inc., Denver, CO (US)

(72) Inventors: Joe Jaudon, Sedalia, CO (US); David Lowrey, Denver, CO (US); Adam Williams, Aurora, CO (US)

(21) Appl. No.: 13/932,194

(22) Filed: Jul. 1, 2013

Related U.S. Application Data
(60) Provisional application No. 61/667,756, filed on Jul. 3, 2012.
(60) Provisional application No. 61/667,758, filed on Jul. 3, 2012.

(51) Int. Cl. H04L 29/06

(52) U.S. Cl. CPC H04L 65/403
USPC 709/204

(57) ABSTRACT

Systems, devices, and methods are described for initiating collaboration activities among multiple terminal devices. A central server computer system may receive a trigger event for a collaboration activity at a central server computer system; identify a set of participants in the collaboration activity; identify a current device associated with each of the identified participants; and apply a set of rules to the received trigger event and the identified participants to preemptively establish a bridge for the collaboration activity between each of the identified devices prior to a start of the collaboration activity.

### CROSS-REFERENCE

The present invention claims priority to U.S. Provisional Application No. 61/667,756, filed Jul. 3, 2012, entitled “COLLABORATION ACTIVITY INITIATION,” and U.S. Provisional Application No. 61/667,758, filed Jul. 3, 2012, entitled “COLLABORATION ACTIVITY WITH MULTIPLE FORM FACTORS,” both of which are assigned to the present assignee and incorporated by reference for all purposes.

### BACKGROUND

The present invention relates to the initiation and coordination of collaboration activities among disparate devices associated with a network.

Collaboration activities allow users at different locations to communicate using mutual access to a shared service. One common type of collaboration activity is that of a conference call in which a bridge device or service physically or logically interconnects telephone lines such that each participant of the conference call may speak to and hear the other participants. Another example of a collaboration activity may be a web conference in which a common display and audio feed are provided to participants at remote locations over a network.

Collaboration activities can be notoriously tedious to set up. For example, conference calls are typically initiated by circulating a dial-in telephone number and a conference code to each participant of the call. Web conferences and other types of shared screens may require each participant to sign into a service or install software prior to entering the conference. As such, these activities can cause participants to unproductively spend time waiting for all of the other participants to successfully connect to the conference. Punctuality is often penalized in such events, as participants who join the collaboration activity on time may be forced to wait for tardy participants to join the activity.

### SUMMARY

Methods, systems, and devices are described for using a central network device to initiate and coordinate collaboration activities among separate network devices.

In a first set of examples, a central server computer system may receive a trigger event for a collaboration activity at a central server computer system; identify a set of participants in the collaboration activity; identify a current device associated with each of the identified participants; and apply a set of rules to the received trigger event and the identified participants to preemptively establish a bridge for the collaboration activity between each of the identified devices prior to a start of the collaboration activity.

In a second set of examples, an apparatus for initiating collaboration activities may include at least one processor and a memory communicatively coupled with the at least one processor. The processor may be configured to execute computer-readable program code causing the at least one processor to receive a trigger event for a collaboration activity; identify a set of participants in the collaboration activity; identify a current device associated with each of the identified participants; and apply a set of rules to the received trigger event and the identified participants to preemptively establish a bridge for the collaboration activity between each of the identified devices prior to a start of the collaboration activity.

In a third set of examples, a system may include a plurality of terminal devices and a central server computer system communicatively coupled with the plurality of terminal devices over a network. The central server computer system may be configured to: receive a trigger event for a collaboration activity; identify a set of participants in the collaboration activity; identify a current one of the terminal devices associated with each of the identified participants; and apply a set of rules to the received trigger event and the identified participants to preemptively establish a bridge for the collaboration activity between each of the identified terminal devices prior to a start of the collaboration activity.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIGS. 2A-2C are diagrams of example terminal devices at different times according to various embodiments of the invention.

FIG. 3 is a diagram of an example of determining rule-based collaboration activity initiation actions for a number of users according to various embodiments of the invention.

FIG. 4 is a block diagram of an example central server computer system according to various embodiments of the invention.

FIGS. 5A and 5B are flowchart diagrams of example methods of initiating a collaboration activity according to various embodiments of the invention.

FIGS. 6A and 6B are diagrams of an example system including components configured according to various embodiments of the invention.

FIG. 7 is a block diagram of an example central server computer system according to various embodiments of the invention.

FIG. 8 is a flowchart diagram of an example method of coordinating a collaboration activity according to various embodiments of the invention.

FIGS. 9A, 9B, and 9C are diagrams of an example system including components configured according to various embodiments of the invention at different points in time.

FIG. 10 is a block diagram of an example central server computer system according to various embodiments of the invention.

FIG. 11 is a flowchart diagram of an example method of coordinating a collaboration activity among multiple form factors according to various embodiments of the invention.

FIG. 12 is a flowchart diagram of an example method of coordinating a collaboration activity among multiple form factors according to various embodiments of the invention.

FIG. 13 is a schematic diagram that illustrates a representative device structure that may be used in various embodiments of the present invention.

### DETAILED DESCRIPTION

Methods, systems, and devices are disclosed for using a central server computer system to initiate and coordinate collaboration activities among separate network devices. The central server computer system may maintain an inventory of devices associated with each user in a set of users. The central server computer system may receive events from different network devices to track which devices are currently in active use by each user. In response to receiving a trigger event, the central server computer system may initiate a collaboration activity and apply a set of rules to the trigger event to identify a number of participants from the set of users. The central server computer system may add the device in active use by each identified participant to the established collaboration stream. In certain examples, the central server computer system may also preemptively establish a logical bridge between the devices prior to a start of the collaboration activity. In certain examples, the central server computer system may merge the data of different types from multiple users into a single collaboration stream, and transmit to each user a version of the collaboration stream adapted to the type of data associated with that user.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “collaboration activity” refers to an activity in which audio, visual, textual, or other data is shared among multiple participants through mutual connections to a common service. For example, a collaboration activity may include, but is not limited to, a conference call, a video conference, sharing a portion of a desktop over a network, a presentation broadcast over a network, and other types of collaborative activities.

As used herein, the term “bridge” refers to a physical or logical connection between multiple devices which enables the devices to exchange data in a collaboration activity.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

Systems, devices, methods, and software are described for collaboration activity initiation and coordination.

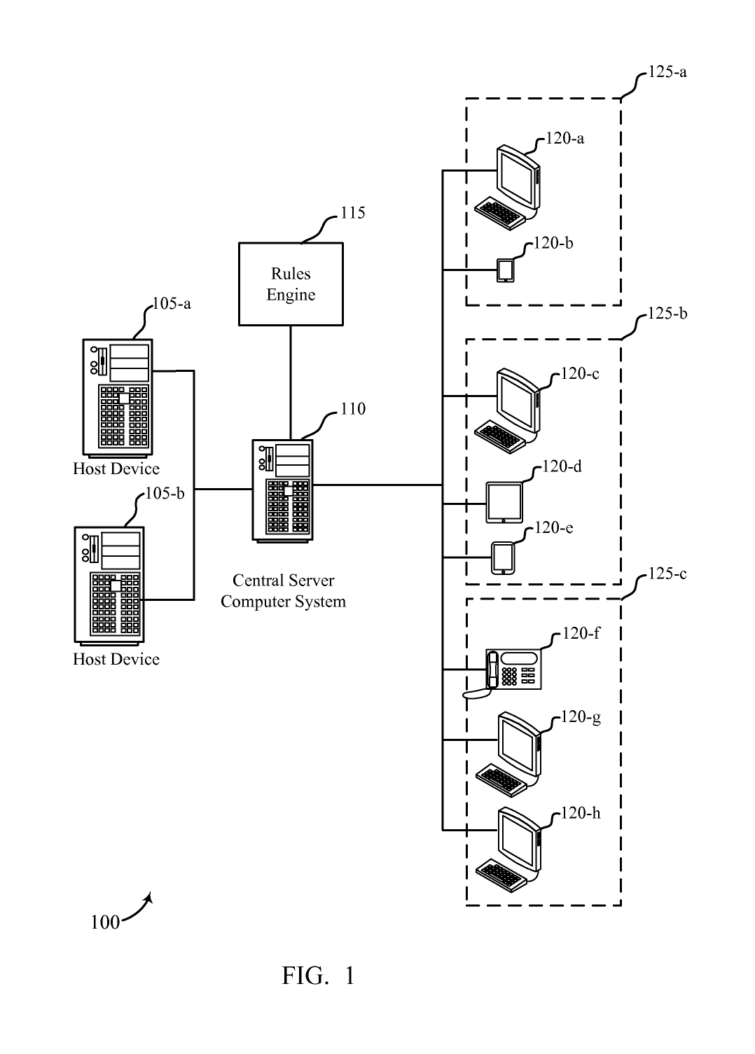

FIG. 1 illustrates an example system 100 including host devices 105, a central server computer system 110, a rules engine 115, terminal devices 120 (e.g., workstations 120-a, 120-c, 120-g, and 120-h; smartphones 120-b and 120-e, tablet 120-d, and telephone 120-f). Each of these components may be in communication, directly or indirectly. The central server computer system 110 may initiate and coordinate collaboration activities among participants based on terminal devices 120 associated with the participants and a set of rules enforced by the rules engine 115.

In certain examples, the host devices 105 may host virtual sessions on behalf of one or more of the users tracked by the central server computer system 110. In certain examples, the central server computer system 110 may implement one or more aspects of the functionality of the host devices 105. Each virtual session hosted at a host device 105 may be associated with a particular user. The central server computer system 110 may forward session packets between the host devices 105-a and the terminal devices 120. A user may access a session hosted by a host device 105 through one of the terminal devices 120. A terminal device 120 may function as a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system based on settings, parameters, and/or remotely hosted applications for the user served from the host device 105.

The rules engine 115 may apply or enforce a set of event-based rules for dynamically modifying certain aspects of the virtual sessions, creating and tearing down virtual sessions, and multiplexing the session data between the host devices 105 and the terminal devices 120. In certain examples, at least a portion of the rules engine 115 may be implemented by or within the central server computer system 110. Additionally or alternatively, at least a portion of the rules engine 115 may be implemented by a device external to the central server computer system 110. The central server computer system 110 may selectively forward session data between the host devices 105 and the terminal devices 120 based on the logical deductions of the rules engine 115.

The association of individual terminal devices 120 with particular users may be tracked by the central server computer system 110. In the present example, a first user may be associated with workstation 120-a and smartphone 120-b, as illustrated by box 125-a. A second user may be associated with workstation 120-c, tablet 120-d, and smartphone 120-e, as illustrated by box 125-b. A third user may be associated with telephone 120-f, workstation 120-g, and workstation 120-h, as illustrated by box 125-c. In certain examples, the central server computer system 110 may associate more than one user with a particular terminal device 120. Additionally or alternatively, one or terminal devices 120 may not be associated with any users.

The central server computer system 110 may also track which of the terminal devices 120 associated with a particular user are being actively used by the user, if any. For example, a first user may be associated with workstation 120-a and smartphone 120-b, but the central server computer system 110 may infer from a logout event received from workstation 120-a that the first user is not actively using the workstation 120-a and that the user is more likely to be reachable through smartphone 120-b.

The central server computer system 110 may receive events from the terminal devices 120 and other devices in communication with the central server computer system 110 to dynamically update its records of which terminal devices 120 are associated with which users and its records of which terminal devices 120 are being actively used by the users.

For example, if a first user logs off of workstation 120-a, the central server computer system 110 may receive a log off event from workstation 120-a and disassociate the workstation 120-a from the first user. If a second user then logs on to workstation 120-a, the central server computer system 110 may receive a log on event from workstation 120-a and associate the second user with the workstation 120-a.

In additional or alternative examples, a terminal device 120 may transmit an inactivity event to the central server computer system 110 after a predefined period of inactivity from the user associated with that terminal device 120. Similarly, when the user begins to use the terminal device 120 again after a period of inactivity, the central server computer system 110 may receive an active use event from the terminal device 120.

In additional or alternative examples, the central server computer system 110 may be configured to update its records regarding the state of terminal devices based on logical deductions and rules. For example, if a log on event is received for a user associated with a first workstation from a second workstation in a different location, the central server computer system 110 may disassociate the user from the first workstation or mark the first workstation as inactive in its association with the user.

The central server computer system 110 may be configured to initiate collaboration activities among the terminal devices 120 in response to a trigger event. The collaboration activity may occur between one or more virtual sessions hosted at host device(s) 105 that are served up to one or more terminal devices 120. The trigger event may be generated based on a request from a user to initiate the collaboration activity. In other examples, the trigger event may be automatically generated in response to a set of predetermined criteria. The trigger event may be received at the central server computer system 110 from any of the host devices 105, the rules engine 115, the terminal devices 120, or be generated within the central server computer system 110. In certain examples, different types of trigger events may be used or a single trigger event may be generated based on a number of other events. The trigger event may occur in connection with a real-time request or instruction to initiate a collaboration activity. Additionally or alternatively, the trigger event may be generated in connection with an inference based on a set of observed conditions indicating a collaboration activity (e.g., time of day, a detected presence of one or more users in a location, a status of one or more devices, a scheduled collaboration activity, etc.).

Once the trigger event is received or generated at the central server computer system 110, the central server computer system 110 may identify a type of collaboration activity associated with the trigger and a number of potential participants for the collaboration activity. The potential participants may be selected from the users tracked by the central server computer system 110.

Upon identifying the potential participants for the collaboration activity, the central server computer system 110 may apply a set of rules from rules engine 115 to the type of collaboration activity requested, data about the potential participants, and/or the trigger event to determine which of the potential participants to invite or directly add to the collaboration activity. For each such participant, the central server computer system 110 may identify an active terminal device 120 associated with that participant and add that terminal device 120 directly to the collaboration activity or send an invitation to that terminal device 120 to allow the participant to join the activity. The central server computer system 110 may facilitate the collaboration activity such that each participant that joins the collaboration activity receives collaboration data at a terminal device 120 associated with that participant. In certain examples, collaboration data received from one a terminal device 120 associated with one participant may be forwarded by the central server computer system 110 to the terminal devices 120 associated with the other participants of the collaboration activity.

Collaboration Activity Initiation

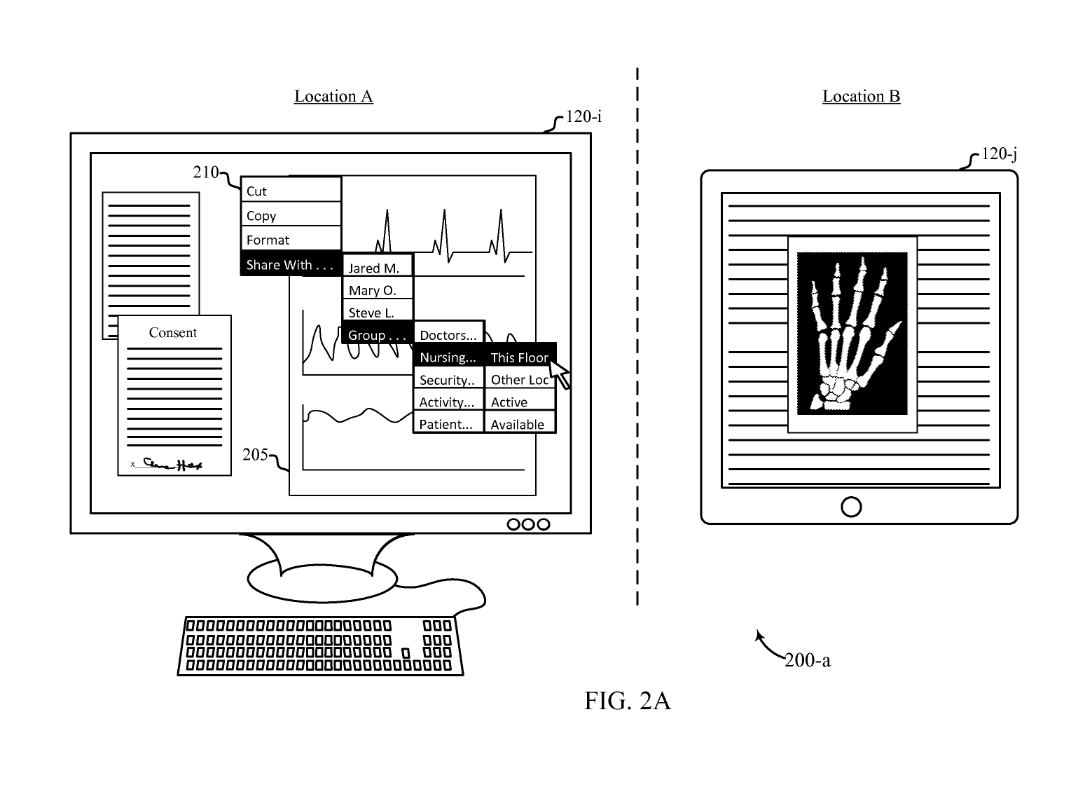

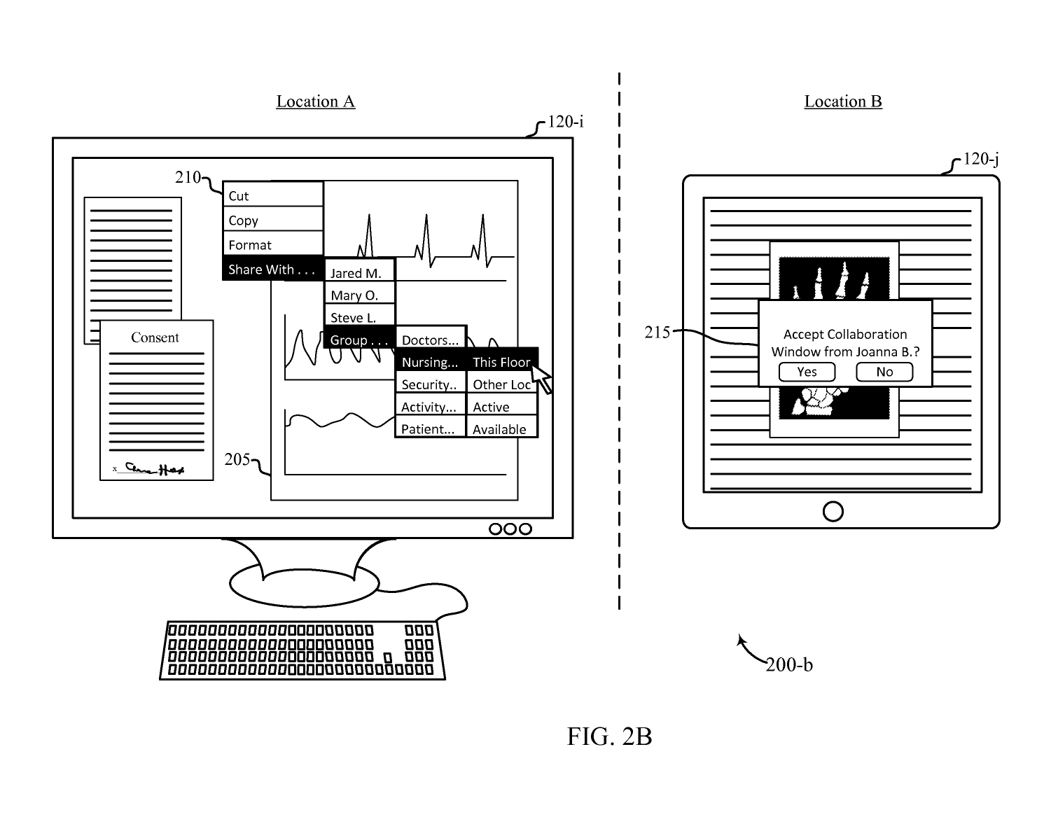

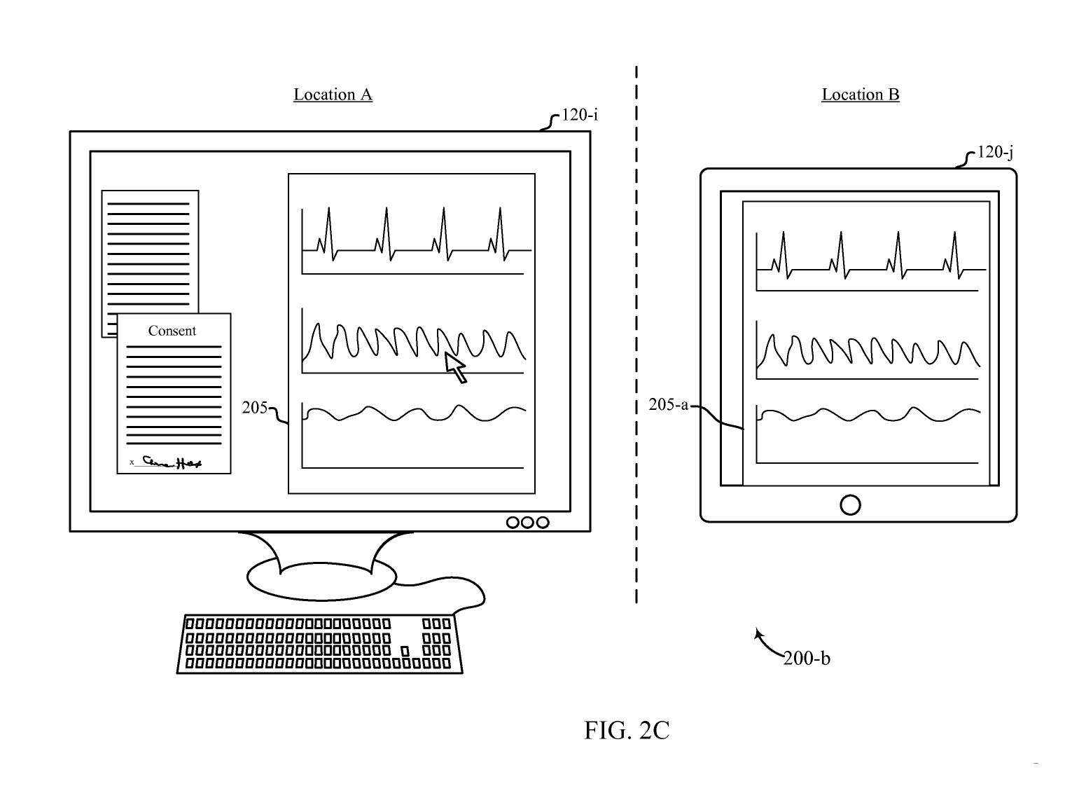

FIGS. 2A-2C illustrate an example of the initiation of a collaboration activity in a system 200 from the perspective of a first terminal device 120-i in a first location and a second terminal device 120-j in a second location. The collaboration activity may occur between one or more virtual sessions hosted at remote host device(s) and/or central server computer system(s) that are served up to the terminal devices 120. The terminal devices of FIGS. 2A-2C may be examples of the terminal devices 120 described above with reference to FIG. 1. In the present example, each of the terminal devices 120 may be associated with a separate user and a separate virtual session hosted at a host device (e.g., host device 105 of FIG. 1) for that user.

At FIG. 2A, the first terminal device 120-i is shown displaying the user interface of a first virtual session hosted at a host device on behalf of the user of the first terminal device. The second terminal device 120-j is shown displaying the user interface of a second virtual session hosted at the host device on behalf of the use of the second terminal device. Because the sessions are different, the user interface desktop to the user of the first terminal device 120-i is different from the user interface displayed to the user of the second terminal device 120-j. For example, the user of the first terminal device 120-i may be viewing consent forms and vital signs for a patient, while the user of the second terminal device 120-j may be viewing x-ray images and documentation for a different patient.

As shown in FIG. 2A, the user of the first terminal device 120-i may choose to share a portion of the user interface displayed by the first terminal device 120-i with a group of users, including the user of the second terminal device 120-j. In certain examples, the operating systems of the virtual sessions associated with the users of the terminal devices 120 may be extended or modified to include built-in collaboration functionality, taking advantage of the fact that the virtual sessions may each be communicatively coupled with a common central server computer system (e.g., central server computer system 110 of FIG. 1). Using this extended collaboration functionality, the user of the first terminal device may be able to select any window shown in the user interface of the virtual session and select a recipient or group of recipients with whom to share that particular window over the network.

In FIG. 2A of the present example, the user of the first terminal device may have selected the window 205 of vital signs (e.g., by right-clicking the window 205 or another method of selection), causing a menu 210 to be displayed. The menu 210 may include an option to share the selected window 205 with an individual user or a group of users. In the example of FIG. 2A, the user of the first terminal device 120-i may have selected the option to specify a group, which may bring up a menu of possible groups to choose from. The possible groups of the present example may include doctors, nursing staff, security staff, personnel currently engaged in a specified activity, or personnel currently associated with a particular patient. Upon selecting the nursing group, the user of the first terminal device may view the option to select nursing staff associated with a current floor, nursing staff associated another location, nursing staff that are currently active (e.g., have active virtual sessions), or nursing staff that are currently available. In the present example, the user of the first terminal device 120-i may have selected nursing staff associated with the current floor.

In response to this selection, the central server computer system in communication with the first and second terminal devices 120 may receive a trigger event to initiate a collaboration activity. The trigger event may be received from the host device hosting the virtual session associated with the user of the first terminal device 120-i. Alternatively, the trigger event may be generated within the central server computer system in response to the central server computer system determining that the user of the first terminal device 120-i has selected the option to share the window 205 with the user of the second terminal device 120-j.

As shown in FIG. 2B, in response to the trigger event, the central server computer system may apply a set of rules to dynamically identify the group of nursing staff who are currently associated with the current floor based at least on dynamically updated identification records, status records, and/or location records associated with users known to the central server computer system. For example, the central server computer system may identify and track all nursing staff currently on duty through the use of access card sensors associated with known locations. Thus, the central server computer system may identify, based on a known location of the user of the first terminal device 120-i and a known location of all nursing staff on duty, a subset of the nursing staff that is currently on duty and present on the same floor as the user of the first terminal device 120-i. In certain examples, the central server computer system may further narrow the identified subset to include only those nursing staff who are currently using or in the vicinity of a terminal device 120.

The user of the second terminal device 120-j may be included in the identified subset of nursing staff on the same floor as the user of the first terminal device 120-i. The central server computer system may identify one or more terminal devices associated with each user in the identified group and automatically initiate the collaboration activity or prompt the user to accept the collaboration activity through that device. For example, as shown in FIG. 2B, the central server computer system may cause a window 215 to appear in the user interface of the second terminal device 120-j. The central server computer system may instruct the host device hosting the session for the second terminal device 120-j to insert the window 215 into the user interface or simply modify the user interface being served to the second terminal device 120-j to insert the window 215. The window 215 may invite the user of the second terminal device 120-j to accept a collaboration window from the user of the first terminal device 120-i.

As shown in FIG. 2C, if the user of the second terminal device 120-j chooses to accept the invitation to view the collaboration window, the selected window 205 from the user interface of the first terminal device 120-i may be duplicated on the display of the second terminal device 120-j. In certain examples, the central server computer system may mirror packets corresponding to the session associated with the user of the first terminal device 120-i to the second terminal device 120-j. The central server computer system may modify the user interface of the session associated with the user of the second terminal device 120-j to display the shared window 205, overlay the shared window 205 on top of the user interface of the session associated with the user of the second terminal device 120-j, or forward the shared window 205 to the second terminal device 120-j instead of the user interface of the session associated with the user of the second terminal device 120-j.

The above example has been given with reference to shared desktop windows for the purpose of clarity. However, it will be understood that these same principles may be applied to a number of different types of collaboration activities. Examples of such collaboration activities include, but are not limited to, videoconferencing, teleconferencing, shared audio, shared text, collaborative file editing, and the like.

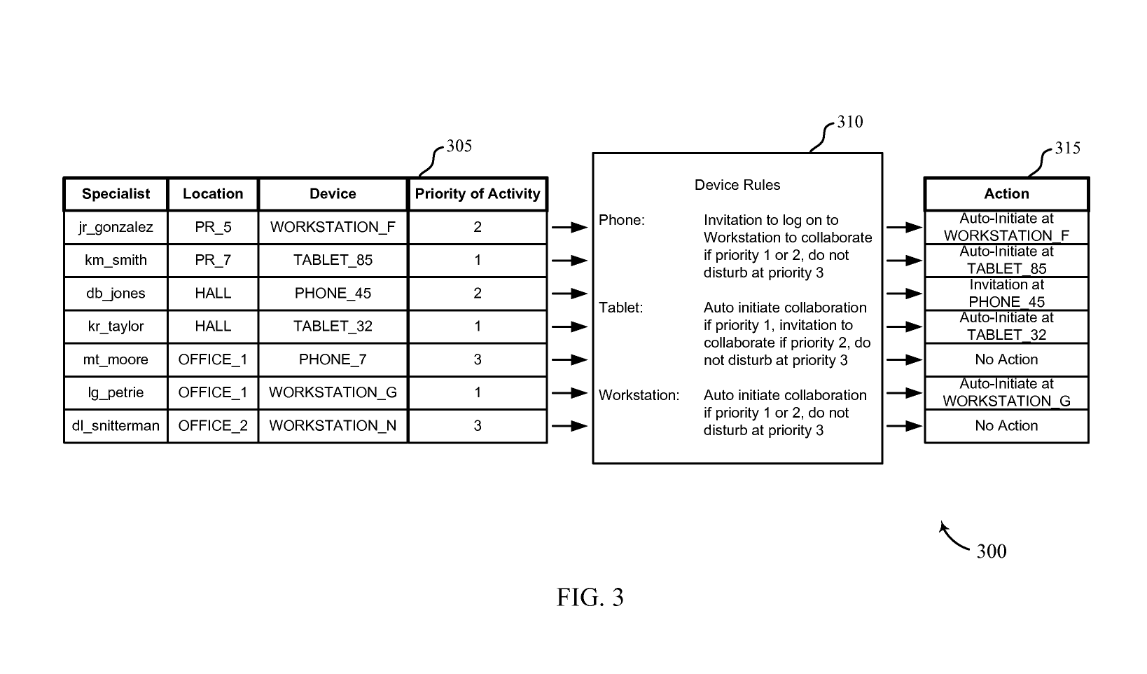

FIG. 3 is a diagram 300 of an example data flow for inviting participants to a collaboration activity in response to a trigger event. In the example of FIG. 3, a number of terminal devices (e.g., terminal devices 120 of FIG. 1) may be distributed across a floor of a hospital. A user may attempt to establish a videoconference collaboration activity with all of the medical practitioners who are specialists and currently on that floor.

A central server computer system (e.g., central server computer system 110 of FIG. 1) may maintain records for each of the registered users on the floor. The data for each user may include a type associated with the user, a location on the floor of the user, a terminal device currently associated with the user, and a priority or importance of an activity, known by the central server computer system in which the user is currently engaged. Thus, when the user requests a new videoconference collaboration activity with all of the specialists on the floor, the central server computer system may query its records of registered users to identify the identity, current location, current terminal device, and priority of activity associated with each specialist. An example of such data is shown in table 305 of FIG. 3.

Once the specialists on the floor have been identified and their records retrieved, a number of rules 310 may be applied to the records to determine, for each of the specialists, whether and how to initiate the videoconference activity with that specialist. In the example of FIG. 3, these rules 310 may operate according to the current terminal device associated with each specialist and the priority of the activity in which that specialist is currently engaged.

For example, as shown in FIG. 3, if a specialist is currently engaged in a priority 3 activity, the specialist is not added to or invited to join the collaboration activity so as not to avoid the specialist. If the specialist is associated with a telephone terminal device and engaged in a priority 1 or 2 activity, the specialist may be invited through a call or message to his or her telephone terminal device to log on to a workstation and join the videoconference. As soon as an invited specialist logs on to a workstation, the central server computer system may automatically and immediately add that workstation to the videoconference without further action by the specialist.

Continuing with the example of FIG. 3, if the specialist is currently associated with a tablet terminal device and engaged in a priority 2 activity, the specialist may receive an invitation on the tablet or workstation terminal device to join the videoconference. If the specialist accepts the invitation, he or she may be instantly added to the videoconference through the tablet terminal device. If the specialist is currently associated with a tablet or workstation terminal device and engaged in a priority 1 activity, the specialist may be automatically added to the videoconference at his or her tablet or terminal device by the central server computer system. If the specialist is currently associated with a workstation terminal device and engaged in a priority 1 or 2 activity, the specialist may be automatically added to the videoconference at his or her workstation terminal device by the central server computer system.

As shown in FIG. 3, the set of rules 310 may be applied to each specialist user identified in table 305, and an action 315 for each specialist with respect to the requested videoconference collaboration activity may be identified based on the rules, the nature of the collaboration activity, and the data stored for each specialist user. The central server computer system may accordingly initiate the requested videoconference collaboration activity and perform the identified actions 315 with respect to each identified specialist user.

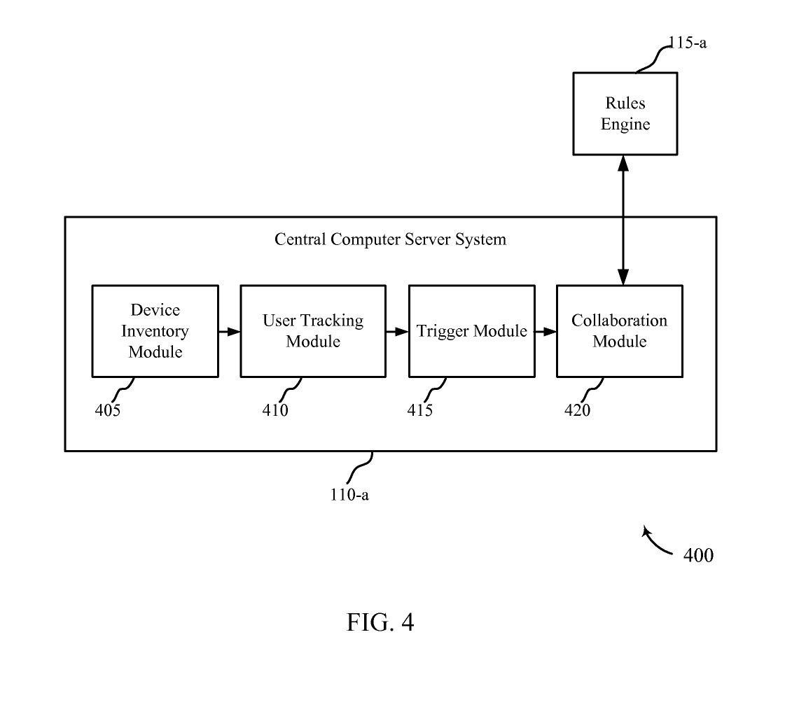

FIG. 4 is a block diagram 400 of an example central server computer system 110-a according to the principles described herein. The central server computer system 110-a may be an example of one or more of the central server computer systems 110 described above with reference to the previous Figures. The central server computer system 110-a of the present example may be used to initiate collaboration activities among terminal devices (e.g., terminal devices 120) in a network, as described in previous examples.

The central server computer system 110-a of the present example may include a device inventory module 405, a user tracking module 410, a trigger module 415, and a collaboration module 420. Each of these components may be in communication, directly or indirectly. The central server computer system 110-a may also be in communication with a rules engine 115-a. The rules engine 115-a may be an example of the rules engine 115 of FIG. 1. In certain examples, the rules engine may be implemented within the central computer server system.

The device inventory module 405 may be configured to maintain a record of terminal devices (e.g., terminal devices 130 of FIGS. 1, 2A-2C) and other devices connected or addressable to the central computer server system through a network. The devices for which records are maintained may include workstations, telephones, tablet computers, smartphones, laptop computers, printing devices, access control devices (e.g., RFID and magnetic card readers, biometric scanners, keypads, etc.), and other types of devices that may suit a particular implementation of the principles described herein.

The user tracking module 410 may be configured to maintain records for a number of users known to the central server computer server system 110-a. The records may, for example, associate certain users with devices tracked by the device inventory module 405. The records may further include known or inferred location information, status information, category information, activity information, priority information, and/or other known or inferred information about the users. In certain examples, where the records associate a particular user with a number of devices, the records may track which (if any) of the devices are known to be in active use by the user or which of the devices is a preferred device for contacting the user. The user tracking module 410 may dynamically update the records tracked by the device inventory module 405 and the user tracking module 410 in response to events received from the devices, events received from other sources, and events generated within the central computer server system 110-a in response to inferences made by the central computer server system 110-a.

The trigger module 415 may be configured to receive a trigger event to initiate a collaboration activity among a number of the users tracked by the user tracking module 410. The trigger event may be received from one of the devices or inferred based on a set of conditions or events observed by the central computer server system. In certain examples, the trigger event may be generated in response to a timer or a time of day. Additionally or alternatively, a trigger event may be generated from a user tapping a proximity card to a card reader or providing credentials in another way. In still other examples, a trigger event may be generated by a user submitting a request for a meeting or other collaboration activity. Other suitable methods of generating trigger events for detection at the trigger module 415 may be used. In certain examples, the trigger event may identify the users selected for participation in the collaboration activity. Additionally or alternatively, the trigger module or another module may infer potential users for the collaboration activity from a set of conditions and rules.

The collaboration module 420 may be configured to apply a set of rules from rules engine 115 to the trigger event, the users selected as participants in the collaboration activity, the identity or type of devices associated with the users selected as participants in the collaboration activity, time of day considerations, location considerations, collaboration activity type and location considerations, and/or other relevant criteria to determine whether and how to add each of the users selected as participants to the collaboration activity. Actions to be taken for each user to be added or invited to the collaboration activity may be determined from the rules. In certain examples, the action to be taken for a user may be at least partially based on a type of device associated with the user, an activity of a device associated with the user, an activity of the user, a location of the user, a category of the user, and/or other relevant criteria. The collaboration module 420 may accordingly instantiate the collaboration activity and take the identified actions to selectively add or invite the relevant users to the collaboration activity through the devices associated with the users.

In certain examples, the device selected to receive an invitation to join the collaboration activity for a user may not be the same as the device selected for the user to use to join the collaboration activity. For example, the user may receive an invitation to join a collaboration activity on a cellular phone, and then log in to a workstation to access the collaboration activity.

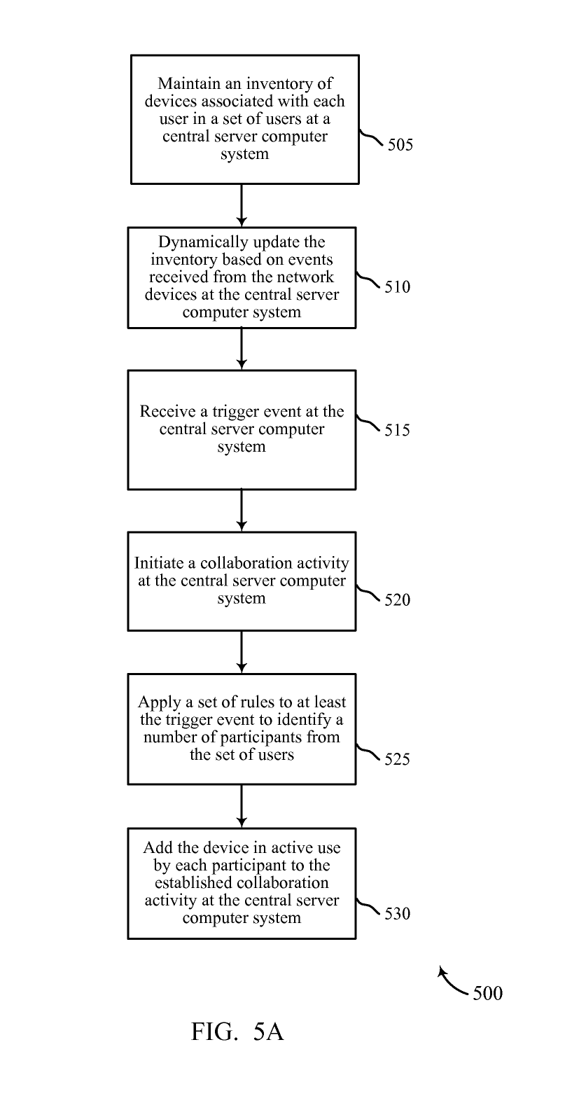

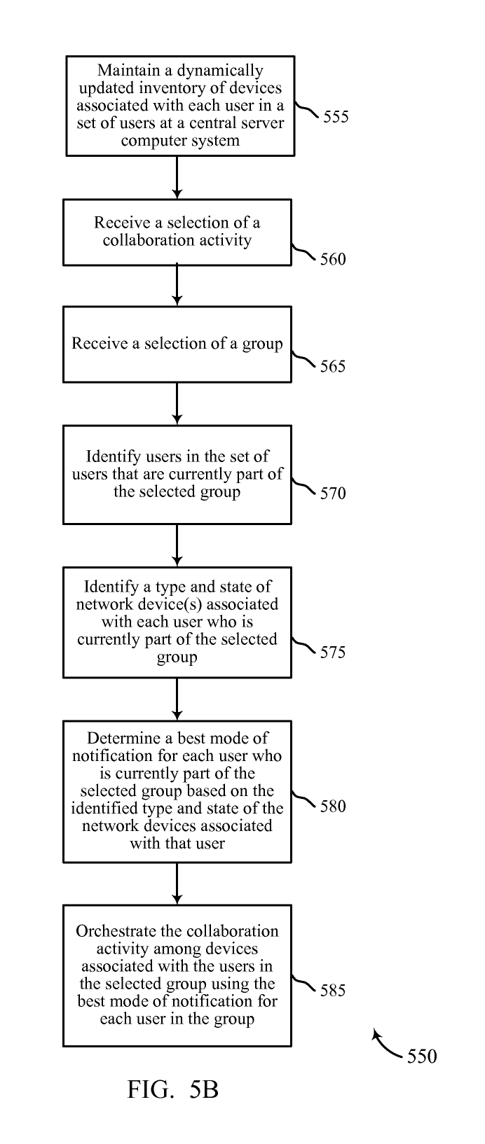

FIG. 5A illustrates a flowchart of an example method 500 of collaboration activity initiation. The method 500 may be performed, for example, by any of the central server computer systems 110 or rules engines 115 described above with reference to FIGS. 1-4.

At block 505, an inventory of devices associated with each user in a set of users may be maintained at a central server computer system. At block 510 the inventory may be dynamically updated based on events received from the network devices at the central server computer system. At block 515, a trigger event may be received at the central server computer system. At block 520, a collaboration activity may be initiated at the central server computer system. At block 525, a set of rules may be applied to at least the trigger event to identify a number of participants from the set of users. At block 530, the device in active use by each identified participant may be added to the established collaboration activity by the central server computer system.

FIG. 5B illustrates a flowchart of another example method 550 of collaboration activity initiation. The method 550 may be performed, for example, by any of the central server computer systems 110 or rules engines 115 described above with reference to FIGS. 1-4.

At block 555, a dynamically updated inventory may be maintained at a central server computer system of devices associated with each user in a set of users. At block 560, a selection of a collaboration activity may be received. At block 565, a selection of a group may be received. At block 570, users in the set of users that are currently part of the selected group may be identified through the application of a set of rules. At block 575, a type and state of network device(s) associated with each user in the group may be identified. At block 580, a best mode of notification may be determined for each user who is currently part of the selected group based on the identified type and state of the network device(s) associated with that user. At block 585, the collaboration activity may be orchestrated among devices associated with the users of the selected group using the identified best mode of notification for each user in the group.

Pre-Access Collaboration Activity Coordination

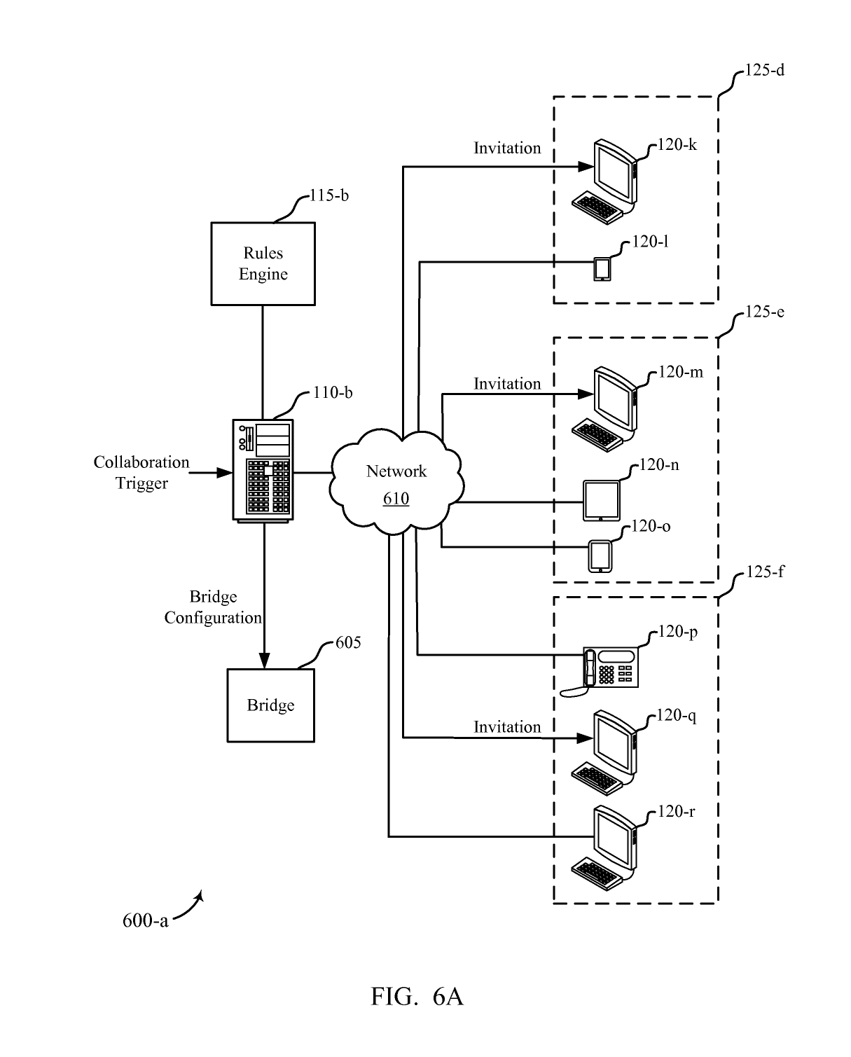

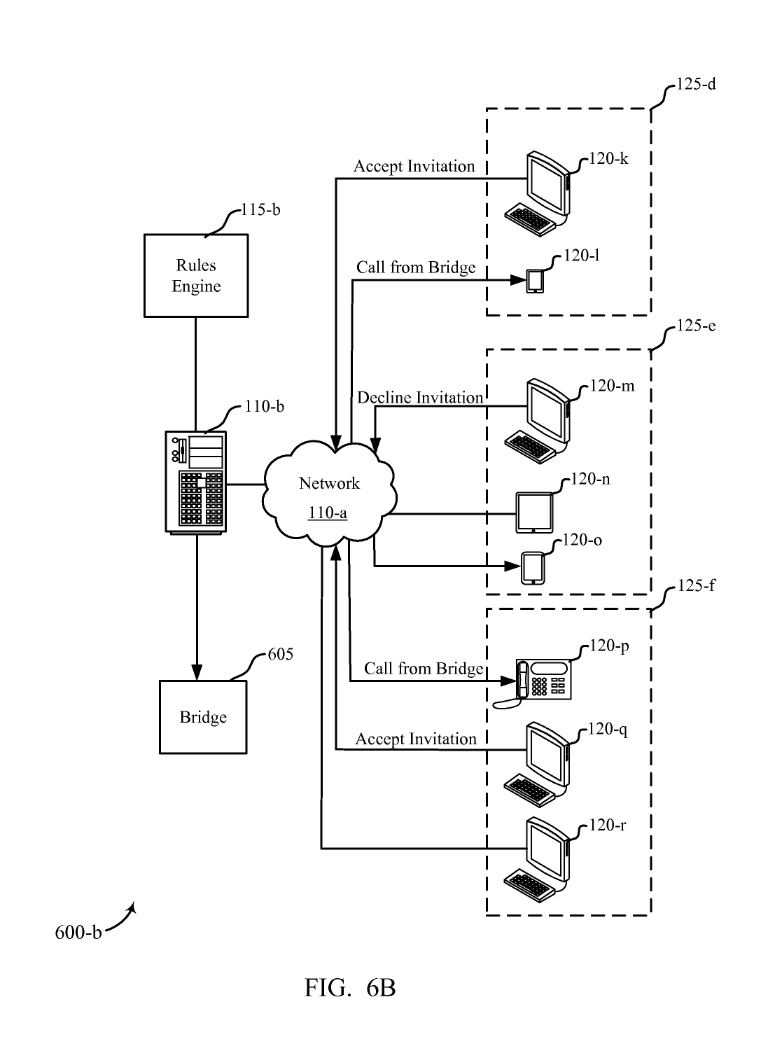

FIGS. 6A-6B illustrate an example system 600 for coordinating a collaboration activity before participants are added to the collaboration activity. The system 600 of FIGS. 6A-6B may be an example of the system 100 described above with reference to FIG. 1.

The system 600 may include a central server computer system 110-b, a network 610, and a number of terminal devices 120. Each of these components may be in communication, directly or indirectly. The central server computer system 110-a may be configured to maintain an inventory of the terminal devices 120 and associate users known to the central server computer system 110-a with the terminal devices 120. The association of users with the terminal devices 120 is depicted using boxes 125, as in FIG. 1.

As in previous Figures, the central server computer system 110-a may receive a triggering event for a collaboration activity and apply a set of rules in rules engine 115-b to identify participant users, determine which terminal devices 120 are in active use by the participant users, select an appropriate terminal device 120 for each invited user to access the collaboration activity, and determine an appropriate action to add the user to the collaboration activity using the appropriate terminal device 120 selected for that user.

However, in the example of FIGS. 6A-6B, the central server computer system 110-b may be configured to establish a logical or physical bridge 605 between the terminal devices 120 selected for each participant user prior to each participant user being invited or added to the collaboration activity. The collaboration activity may occur between one or more virtual sessions hosted at a host device and/or central server computer system 110-b that are served up to the terminal devices 120. In certain examples, the logical bridge may be established by establishing communication between virtual sessions hosted for each terminal device at the central server computer system 110-b. In this way, the user participants may join the collaboration activity immediately without having to dial in to the activity, download software, or navigate to a website. Thus, by delegating the set up of the physical and logical infrastructure of the collaboration activity to the fully automated central server computer system 110-a, user participant time may be saved and technical difficulties may be reduced.

At FIG. 6A, the central server computer system 110-b receives a collaboration trigger. In the present example, the collaboration trigger may be for a conference call. However, in other embodiments the collaboration trigger may identify a different type of collaboration activity, such as a videoconference or shared desktop. As described previously, the collaboration trigger may be received from one of the terminal devices 120, from another device, or generated within the central server computer 110-b.

In response to the collaboration trigger, the central server computer system 110-b may identify each of the three users associated with the terminal devices 120 of FIG. 6A as potential participants in a conference call, and determine that each of the users is to receive an invitation to join the conference call. The central server computer system 110-a may determine that each user is actively using a workstation, and transmit an invitation to workstation 120-k, 120-m, and 120-q to join the conference call. Prior to or substantially concurrent to the transmission of the invitations, the central server computer system 110-a may establish a logical or physical bridge 605 between smartphone 120-l, smartphone 120-o, and conventional telephone 120-p. This bridge 605 may be implemented entirely by the central server computer system 110-a and the network 110-a. Alternatively, the bridge 605 may be implemented using external cellular and landline telephone networks and protocols.

At FIG. 6B, responses to the invitations may be transmitted to the central server computer system 110-b from the workstations 120-k, 120-m, 120-q over the network 110-a. In the present example, the users of workstations 120-k and 120-q have accepted the invitation to join the conference call, and the user of workstation 120-m has declined the invitation. Because the bridge 605 between the users has already been set up by the central server computer system 110-a, the users accepting the invitation may receive calls from the bridge at smartphone 120-l and telephone 120-p, respectively, immediately following their acceptance. When these calls are answered, the users may be automatically connected in a conference call with each other without having to dial in, enter credentials, or take other action to set up the conference call. In alternative examples, one or more of the users may provide authentication credentials to the central server computer system 110-a (e.g., by swiping an access card, entering a PIN, etc.) prior to receiving the call from the bridge 605.

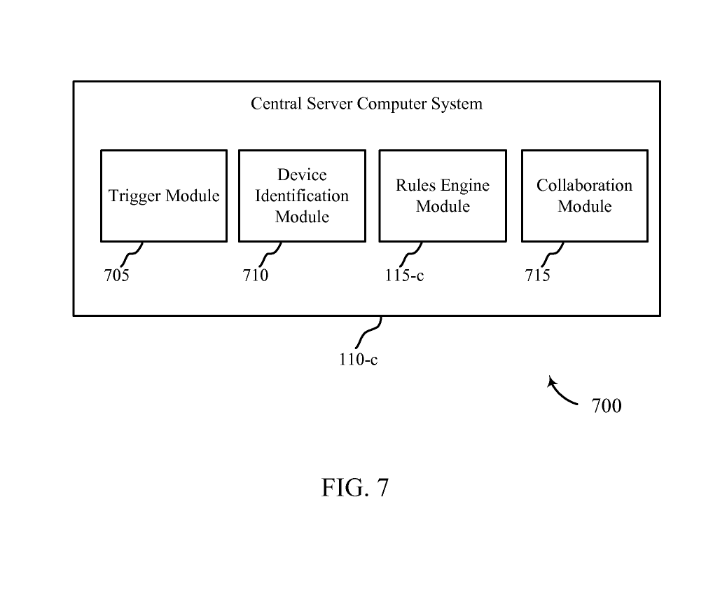

FIG. 7 is a block diagram 700 of an example central server computer system 110-c according to the principles described herein. The central server computer system 110-c may include a trigger module 705, a device identification module 710, a rules engine module 115-c, and a collaboration module 715. Each of these components may be in communication, directly or indirectly. The central server computer system 110-c may be an example of one or more of the central server computer systems 110 described above with reference to the previous Figures.

The trigger module 705 may receive a trigger event informing the central server computer system that a collaboration activity is about to occur. The collaboration activity may have been previously scheduled or dynamically requested in real-time. The device identification module 710 may be configured to identify a set of participants associated with the collaboration activity and a current device associated with each of the participants. The rules engine module 115-c may be configured to apply a set of rules to at least one of the set of participants, the identified devices, or the collaboration activity to identify a set of one or more actions to take to establish a physical or logical bridge between each of the identified devices for the collaboration activity. The collaboration module 715 may preemptively establish the bridge between the devices prior to a start of the collaboration activity.

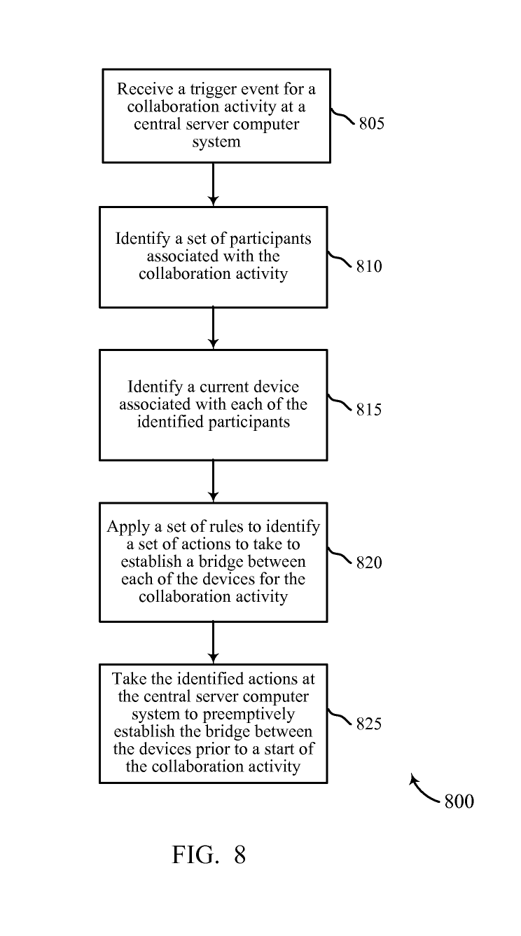

FIG. 8 illustrates a flowchart of another example method 800 of initiating and coordinating a collaboration activity. The method 800 may be performed, for example, by any of the central server computer systems 110 described above with reference to the preceding Figures.

At block 805, a trigger event for a collaboration activity may be received at a central server computer system. At block 810, a set of participants associated with the collaboration activity may be identified. At block 815, a current device associated with each of the identified participants may be identified. At block 820, a set of rules may be applied at the central server computer system to identify a set of actions to take to establish a physical or logical bridge between each of the devices for the collaboration activity. At block 825, the identified actions may be taken at the central server computer system to preemptively establish the bridge between the identified devices prior to a start of the collaboration activity.

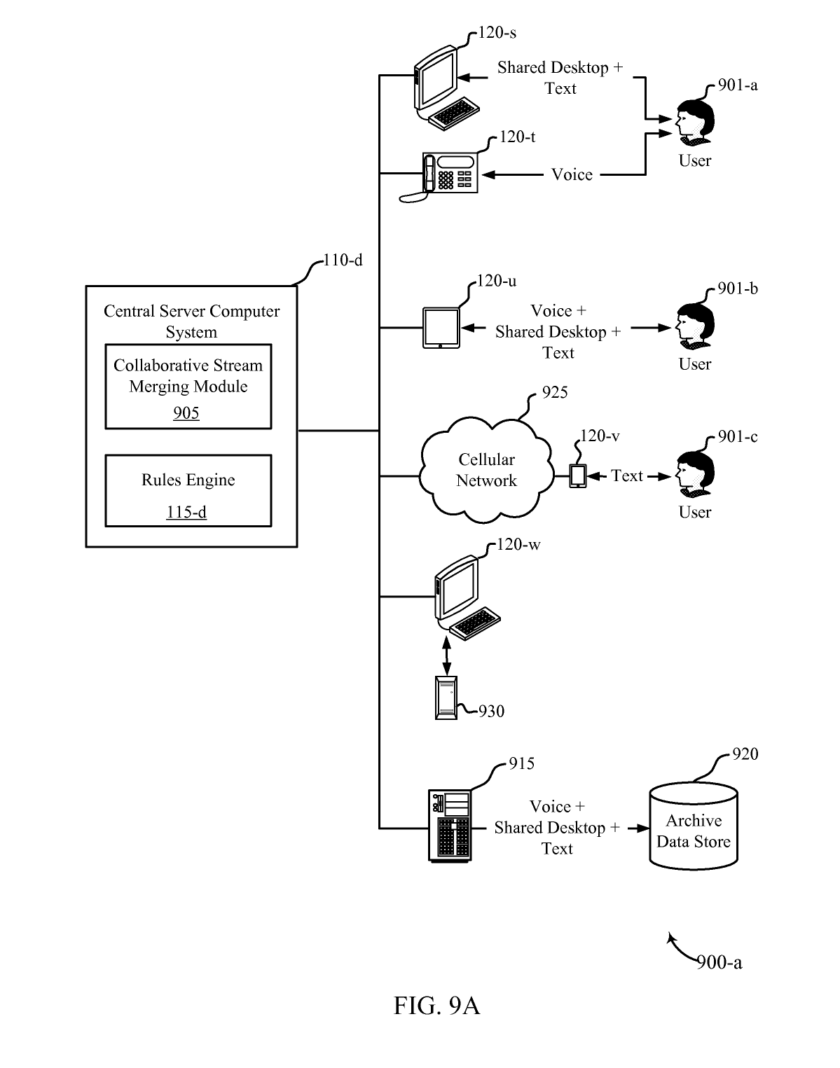

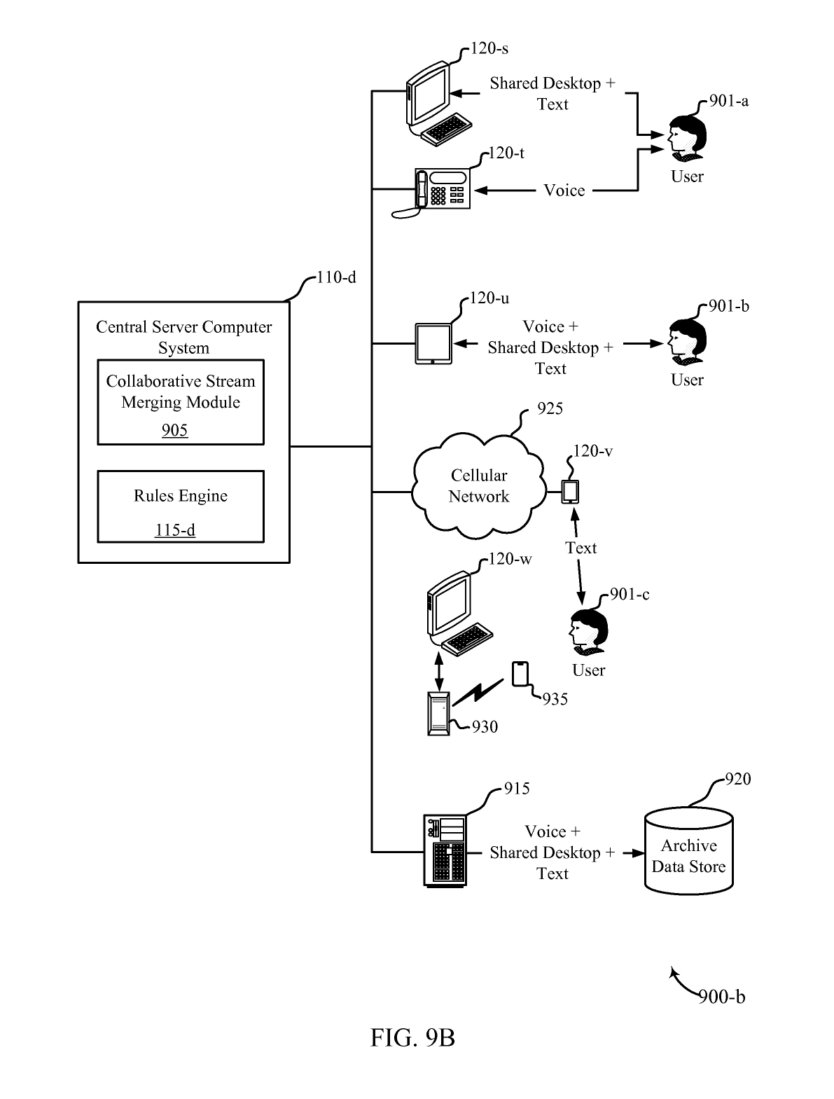

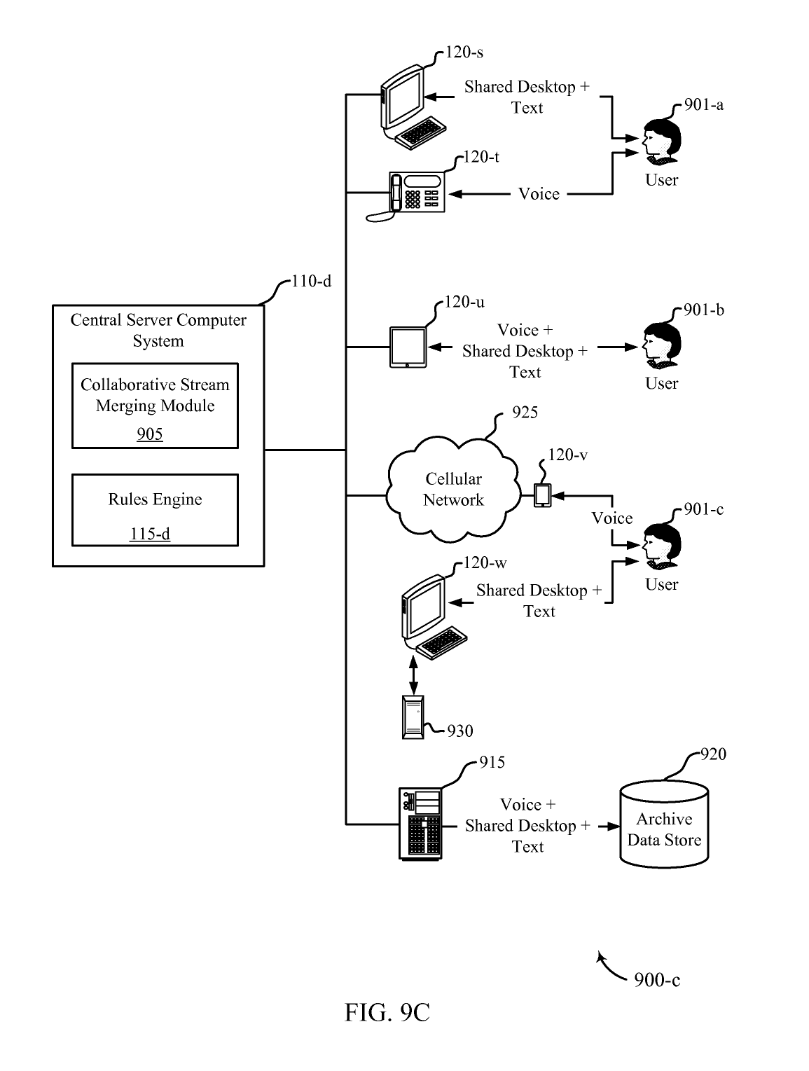

FIGS. 9A-9C illustrate an example of a system 900 in which a central server computer system 110-d coordinates a collaboration activity among heterogeneous terminal devices 120 associated with participant users 901. The system 900 of FIGS. 9A-9C may be an example of the system 100 of FIG. 1. Thus, the central server computer system 110-d and terminal devices 120 of FIGS. 9A-9C may be examples of the central server computer system 110 terminal devices 120 described above with reference to the previous Figures.

The association of individual terminal devices 120 with particular users 901 may be tracked by the central server computer system 110-d. In the present example, the terminal devices 120 may include at least a first workstation 120-s, an Internet Protocol (IP) telephone 120-t, a tablet 120-u, a smartphone 120-v, and a second workstation 120-w. At least the smartphone 120-v of the present example may connect to the central server computer system 110-d through a cellular network 925. Additionally, the second workstation 120-w may be communicatively coupled with a proximity card reader 930 configured to produce access events when a valid proximity card is brought near the proximity card reader 930. The second workstation 120-w may be configured to forward such access events to the central server computer system 110-d for processing.

As noted above, the central server computer system 110-d may track individual users 901 of the system 900 and maintain a dynamically updated record of which users 901 are associated with which terminal devices 120. In certain examples, the central server computer system 110-d may associate more than one user with a particular terminal device 120. Additionally or alternatively, one or more terminal devices 120 may not be associated with any users 901. Moreover, at certain times, one or more users 901 may not be associated with any of the terminal devices 120.

The central server computer system 110-d may also track which of the terminal devices 120 associated with a particular user 901 is being actively used by the user 901, if any. For example, a first user may be associated with workstation 120-s and IP telephone 120-t, but the central server computer system 110-d may infer from a logout event received from workstation 120-s that the first user is not actively using the workstation 120-s and that the user is more likely to be reachable through a smartphone.

The central server computer system 110-d may receive events from the terminal devices 120 and other devices in communication with the central server computer system 110-d to dynamically update its records of which terminal devices 120 are associated with which users 901 and its records of which terminal devices 120 are being actively used by the users 901.

For example, if a user logs off of workstation 120-s, the central server computer system 110-d may receive a log off event from workstation 120-s and disassociate the workstation 120-s from that user. If a different user then logs on to workstation 120-s, the central server computer system 110-d may receive a log on event from workstation 120-d and associate the new user with the workstation 120-s.

In additional or alternative examples, a terminal device 120 may transmit an inactivity event to the central server computer system 110-d after a predefined period of inactivity from the user associated with that terminal device 120. Similarly, when a user 901 begins to use a terminal device 120 again after a period of inactivity, the central server computer system 110-d may receive an active use event from that terminal device 120.

In additional or alternative examples, the central server computer system 110-d may be configured to update its records regarding the state of terminal devices based on logical deductions and rules. For example, if a log on event is received for a user associated with a first workstation from a second workstation in a different location, the central server computer system 110 may disassociate the user from the first workstation or mark the first workstation as inactive in its association with the user.

In connection with tracking the terminal devices 120 associated with each known user, the central server computer system 110 may further be configured to associate each user connected to a terminal device with one or more types of data for the purpose of collaboration activities. The data type(s) identified for each user may be based on the type of terminal devices 120 with which each user is associated. For example, a user of IP telephone 120-b may be associated with the ability to send and receive voice/audio data, a user of smartphone 120-d may be associated with the ability to send and receive voice or text data (but only one type of data at a time), and a user of workstation 120-a or tablet 120-c may be associated with the ability to transmit and receive visual (e.g., shared desktop data) data, text data, and audio data concurrently. In examples where a single user is associated with multiple terminal devices 120, the data types identified for that user may be based on the capabilities of the multiple terminal devices 120 in combination. For example, if a user is in an office with access to workstation 120-a and IP phone 120-b, that user may be associated with a capability to send and receive text and visual data over the workstation and voice/audio data over the IP telephone 120-b.

The central server computer system 110-d may be configured to initiate collaboration activities among the terminal devices 120 in response to a trigger event. The trigger event may be generated based on a request from a user to initiate the collaboration activity. In other examples, the trigger event may be automatically generated in response to a set of predetermined criteria. The trigger event may be received at the central server computer system 110-d from one or more host devices (not shown) implemented by the central server computer system 110-d or separate from the central server computer system 110-d, the rules engine 115-d, or one or more terminal devices 120.

In certain examples, the trigger event may be generated within the central server computer system 110-d. In certain examples, different types of trigger events may be used or a single trigger event may be generated based on a number of other events. Once the trigger event is received or generated at the central server computer system 110-d, the central server computer system 110-d may identify a type of collaboration activity associated with the trigger and a number of potential participants for the collaboration activity. The potential participants may be selected from the users tracked by the central server computer system 110-d.

Upon identifying the potential participants for the collaboration activity, the central server computer system 110-d may apply a set of rules from the rules engine 115-d to the type of collaboration activity requested, data about the potential participants, and/or the trigger event to determine which of the potential participants to invite or directly add to the collaboration activity. For each such participant, the central server computer system 110-d may identify an active terminal device 120 associated with that participant and add that terminal device 120 directly to the collaboration activity or send an invitation to that terminal device 120 to allow the participant to join the activity. The central server computer system 110-d may facilitate the collaboration activity such that each participant that joins the collaboration activity receives collaboration data at a terminal device 120 associated with that participant. In certain examples, collaboration data received from one terminal device 120 associated with one participant may be forwarded by the central server computer system 110-d to the terminal devices 120 associated with the other participants of the collaboration activity.

Because different participants in the collaboration activity may be associated with different types of terminal devices 120, it may be possible that not all of the participants in the collaboration activity support the same type of collaboration data. Accordingly, the central server computer system 110-d may receive different types of collaboration data from different terminal devices 120, merge the heterogeneous data types into a single collaboration stream, adapt the collaboration stream for each participant based on the data type capabilities of that participant, and distribute the adapted collaboration stream to the terminal devices 120 associated with the participants.

Turning now specifically to FIG. 9A, a first user 901-a may be using workstation 120-s and IP telephone 120-t, a second user 901-b may be using tablet 120-u, and a third user 901-c may be using smartphone 120-v. The central server computer system 110-d may track the users 901 and associate each user 901 with its respective terminal device 120. Based on the terminal devices 120 in use by each user 901, the rules engine 115-d of the central server computer system 110-d may further associate each user 901 with one or more collaboration data types.

In the present example, the first user 901-a may be associated with the ability to send and receive visual collaboration data in the form of a shared desktop and text through workstation 120-s, and with the ability to send and receive voice/audio data through IP telephone 120-t. Similarly, the second user 901-b may be associated with the ability to send and receive audio/voice collaboration data, shared desktop visual collaboration data, and textual collaboration data through tablet 120-u. The third user 901-c may be associated with the ability to send and receive textual collaboration data (e.g., via SMS) through smartphone 120-v. In certain examples, the collaboration data type(s) associated with a particular user 901 may further be based on a status or location of the user 901. For example, smartphone 120-v may be technically capable of sending and receiving audio or voice collaboration data, but based on a status of the third user 901-c (e.g., the third user 901-c is on board a noisy bus), the rules engine 115-a of the central server computer system 110-d may temporarily associate the third user 901-c with the ability to send and receive only textual collaboration data.

In certain examples, a user 901 may be associated with one collaboration data type or set of collaboration data types in one direction (e.g., transmitting collaboration data to the central server computer system 110-d) and with another data type or set of collaboration data types in another direction (e.g., receiving collaboration data from the central server computer system 110-d).

In the example of FIG. 9A, the central server computer system 110-d may, in response to the triggering event, identify the first, second, and third users 901 as participants in a collaboration activity and initiate the collaboration activity. In the collaboration activity, the first user 901-a may transmit shared desktop and textual collaboration data to the central server computer system 110-d through workstation 120-s and voice collaboration data to the central server computer system 110-d through IP telephone 120-t. The second user 901-b may transmit voice, shared desktop, and textual collaboration data to the central server computer system 110-d using tablet 120-u. The third user 901-c may transmit SMS textual collaboration data to the central server computer system 110-d using smartphone 120-v.

The central server computer system 110-d may receive these heterogeneous types of collaboration data from the various terminal devices 120, and a collaborative stream merging module 905 of the central server computer system 110-d may combine all of the collaboration data into a single stream of merged collaboration data. The merged collaboration data may then be adapted for transmission to each of the terminal devices 120 participating in the collaboration activity. This adaptation may be based on the type and characteristics of the terminal devices 120.

Thus, the merged collaboration stream may be adapted to provide visual and textual components of the collaboration activity to workstation 120-s and voice components of the collaboration activity to IP telephone 120-t. In this way, the first user 901-a may view a desktop shared with the second user 901-b and textual components contributed by each of the users 901 on workstation 901-f and participate in a voice conference with the second user 901-b through IP telephone 120-t. Additionally, the merged collaboration stream may be adapted to provide the shared desktop, textual, and audio components of the collaboration activity to tablet 120-u, thereby allowing the second user 901-b to participate in the shared desktop and voice conference with the first user 901-a and view textual components contributed by each of the users 901.

The merged collaboration stream may be further adapted to provide a textual version of the stream to the smartphone 120-v via SMS messages which allow the third user 901-c to participate in the collaboration activity by text. It should be understood that the textual version of the merged collaboration stream may include more than simply the textual components contributed by each of the users 901 to the stream. Rather, the stream may be adapted to include textual versions of shared desktop and audio components contributed by the first and second users 901-a, 901-b to the extent practicable. For example, the textual version of the merged collaboration stream transmitted to the smartphone 120-v may include a transcription of certain elements of the voice conversation between the first and second users 901-a, 901-b and/or a description or metadata associated with shared desktop data in the merged collaboration stream from the first and second users 901-a, 901-b.

In certain examples, the central server computer system 110-d may also treat an archive device 915 associated with an archive data store 920 as a participant user in the collaboration activity. While the archive device 915 may not actively contribute collaboration data to the collaboration activity, the central server computer system 110-d may transmit all components of the merged collaborative stream to the archive device 915 for storage in the archive data store 920. In this way, a record of the entire collaboration activity may be maintained for later access.

At FIG. 9B, the third user 901-c may begin moving to workstation 120-w. As the third user 901-c moves, the third user 901-c may continue to send textual content to the central server computer system 110-d via SMS messages using smartphone 120-v for inclusion in the merged collaborative stream. The third user 901-c may also continue to receive a textual version of the merged collaborative stream via SMS messages from the central server computer system 110-d to the smartphone 120-v. As the third user 901-c arrives at workstation 120-w, the third user 901-c may tap an access card 935 associated with the third user 901-c to the access card reader 930 communicatively coupled with workstation 120-w. The access card reader 930 may receive an access token from the access card 935 and generate an access event, which may be forwarded from workstation 120-w to the central server computer system 110-d for processing. The central server computer system 110-d may receive the access event, and the rules engine 115-a may associate workstation 120-w with the third user 901-c.

At FIG. 9C, the system 900 is shown after the third user 901-c has been associated with workstation 120-w by the central server computer system 110-d. Workstation 120-w may be dynamically added to the collaboration activity by the central server computer system 110-d. As such, workstation 120-w may be automatically configured to receive shared desktop collaboration data and textual collaboration data from the third user 901-c for forwarding to the collaborative stream merging module 905 of the central server computer system 110-d. Workstation 120-w may also receive a version of the merged collaboration stream that includes shared desktop data and textual data from each of the users 901.

Moreover, in response to the central server computer system 110-d associating the third user 901-c with workstation 120-w, smartphone 120-v may be automatically configured to transition from sending and receiving text messages on behalf of the third user 901-c to providing voice data from the third user 901-c to the collaborative stream merging module 905 and receiving the audio version of the combined collaboration stream from the central server computer system 110-d. In certain examples, the central server computer system 110-d may automatically call the third user 901-c on smartphone 120-v to set up this new role for the smartphone 120-v in the collaboration activity.

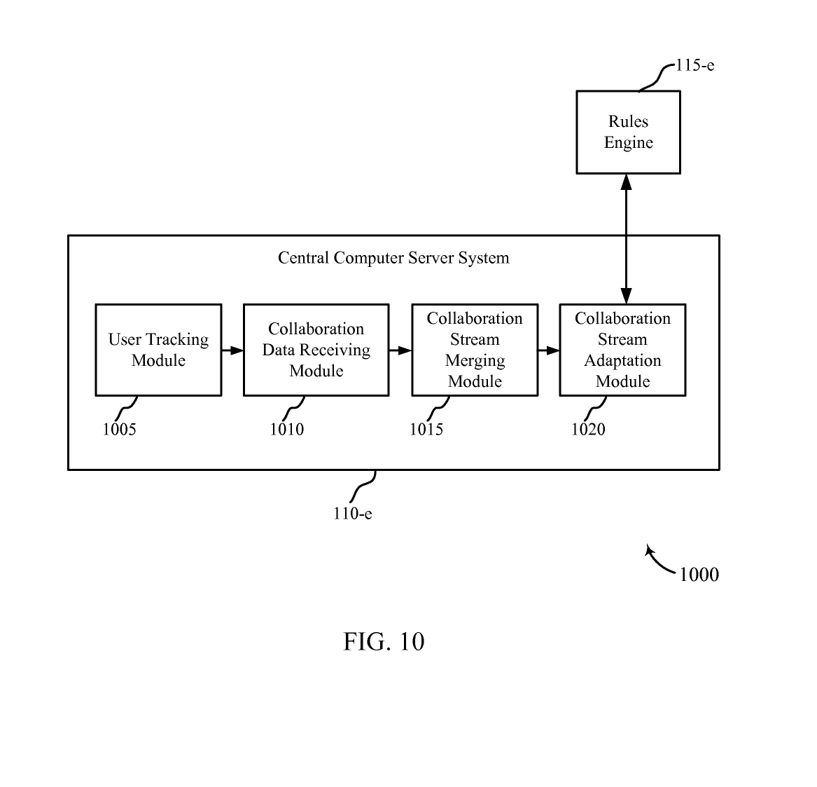

FIG. 10 is a block diagram 1000 of an example central server computer system 110-e according to the principles described herein. The central server computer system 110-e may be an example of one or more of the central server computer systems 110 described above with reference to the previous Figures. The central server computer system 110-e of the present example may be used to initiate, coordinate, maintain, and adapt collaboration activities among terminal devices (e.g., terminal devices 120 of FIGS. 1-2) in a network, as described with respect to the previous examples.

The central server computer system 110-e of the present example may include a user tracking module 1005, a collaboration data receiving module 1010, a collaboration stream merging module 1015, and a collaboration stream adaptation module 1020. Each of these components may be in communication, directly or indirectly. The central server computer system 110-e may also be in communication with a rules engine 115-b. The rules engine 115-e may be an example of one or more of the rules engines 115 described above with reference to previous Figures. In certain examples, the rules engine 115-e may be implemented as a module within the central computer server system central server computer system 110-e.

The user tracking module 1005 may be configured to maintain a record of terminal devices (e.g., terminal devices 120) and other devices connected or addressable to the central server computer system 110-e through a network. The devices for which records are maintained may include workstations, telephones, tablet computers, smartphones, laptop computers, printing devices, access control devices (e.g., RFID and magnetic card readers, biometric scanners, keypads, etc.), and/or other types of devices that may suit a particular implementation of the principles described herein. The user tracking module 1005 may associate devices with known users. This association may be determined using events or other data received from the devices, including known or inferred location information, status information, category information, activity information, priority information, and/or other known or inferred information about the users.

In certain examples, where the records associate a particular user with a number of devices, the records may track which (if any) of the devices are known to be in active use by the user or which of the devices is a preferred device for contacting the user. By associating individual users with individual devices, the user tracking module 1005 may maintain a record of data types associated with each user based on the type of device(s) associated with that user. The user tracking module 1005 may also maintain a record of specific applications in use by each user on the device(s) associated with that user. The applications in use by the user may affect the type and formatting of collaboration data that the user may send and receive to the central server computer system 110-e. Consequently, the record of data types supported by each user may be at least partially affected by the applications in use by the user.

The user tracking module 1005 may dynamically update the records in response to events received from the devices, events received from other sources, and events generated within the central server computer system 110-a in response to inferences made by the central server computer system 110-a. As users migrate among the devices, the user tracking module 1005 may dynamically update its records of the associations between devices and users.

The collaboration data receiving module 1010 may be configured to receive collaboration data in heterogeneous form factors or data types from different users participating in a collaboration activity. In one example, the collaboration data receiving module 1010 may receive SMS text data from one user; streaming shared desktop video data from a second user, shared file data from a third user; voice data from a fourth user; and steaming shared desktop video data from a fifth user.

The collaboration stream merging module 1015 may merge all of the collaboration data received at the collaboration data receiving module 1010 into a single stream of collaboration data. The collaboration stream adaptation module 1020 may then adapt the single stream of collaboration data to the type(s) of data associated with each individual user participant of the collaboration activity and deliver to that user participant a version of the collaboration stream which is adapted to the data type(s) associated with the user participant. For example, if a user participant is associated with a first device capable of receiving audio data and a second device capable of receiving video data, the collaboration stream adaptation module 1020 may provide an audio version of the merged stream to the first device and a video version of the merged stream to the second device. In another example, if a user participant is associated with a device capable of receiving SMS text messages and audio data but the user participant is not in a position to receive audio data, the collaboration stream adaptation module 1020 may adapt video and audio components of the merged collaboration stream to text and transmit a text version of the merged collaboration stream to the user by SMS text message.

The collaboration stream merging module 1015 and the collaboration stream adaptation module 1020 may be configured to dynamically update the collaboration stream in response to changes in devices used by the participant users during the course of the collaboration activity. Thus, if a participant user dynamically moves during the course of the collaboration stream to a different device capable of producing a type of collaboration data not previously associated with that user, user tracking module 1005 may receive one or more events that inform the user tracking module 1005 that the participant user has moved to a new device. The collaboration stream merging module 1015 may accordingly dynamically merge the collaboration data from the new device into the stream of collaboration data for the activity. Additionally, if new device is capable of receiving different types of collaboration data than were previously associated with the participant user, the collaboration stream adaptation module 1020 may update how the collaboration stream is adapted and delivered to the participant user based on the capabilities of the new device.

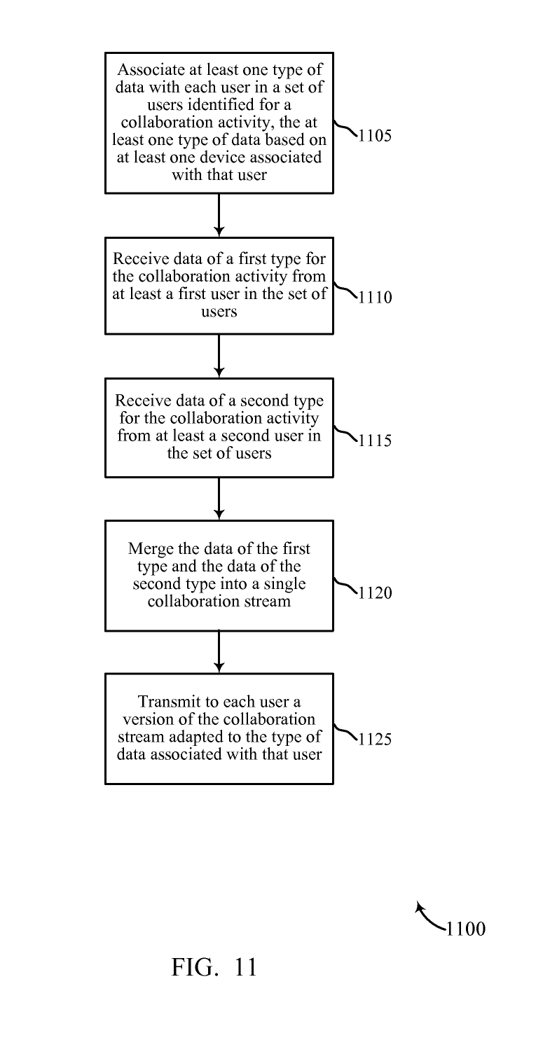

FIG. 11 illustrates a flowchart of an example method 1100 of collaboration activity coordination among multiple form factors. The method 1100 may be performed, for example, by one or more of the central server computer systems 110 or rules engines 115 described above with reference to the previous Figures.

At block 1105, at least one type of data (i.e., a form factor) may be associated with each user in a set of users identified for a collaboration activity. The at least one type of data associated with each user may be selected based on the capabilities of at least one device associated with that user. At block 1110, data of a first type may be received for the collaboration activity from at least a first user in the set of users. At block 1115, data of a second type may be received for the collaboration activity from at least a second user in the set of users. At block 1120, the data of the first type and the data of the second type may be merged into a single collaboration stream. At block 1125, a version of the collaboration stream may be transmitted to each user, the version transmitted to each user being adapted to the type of data associated with that user.

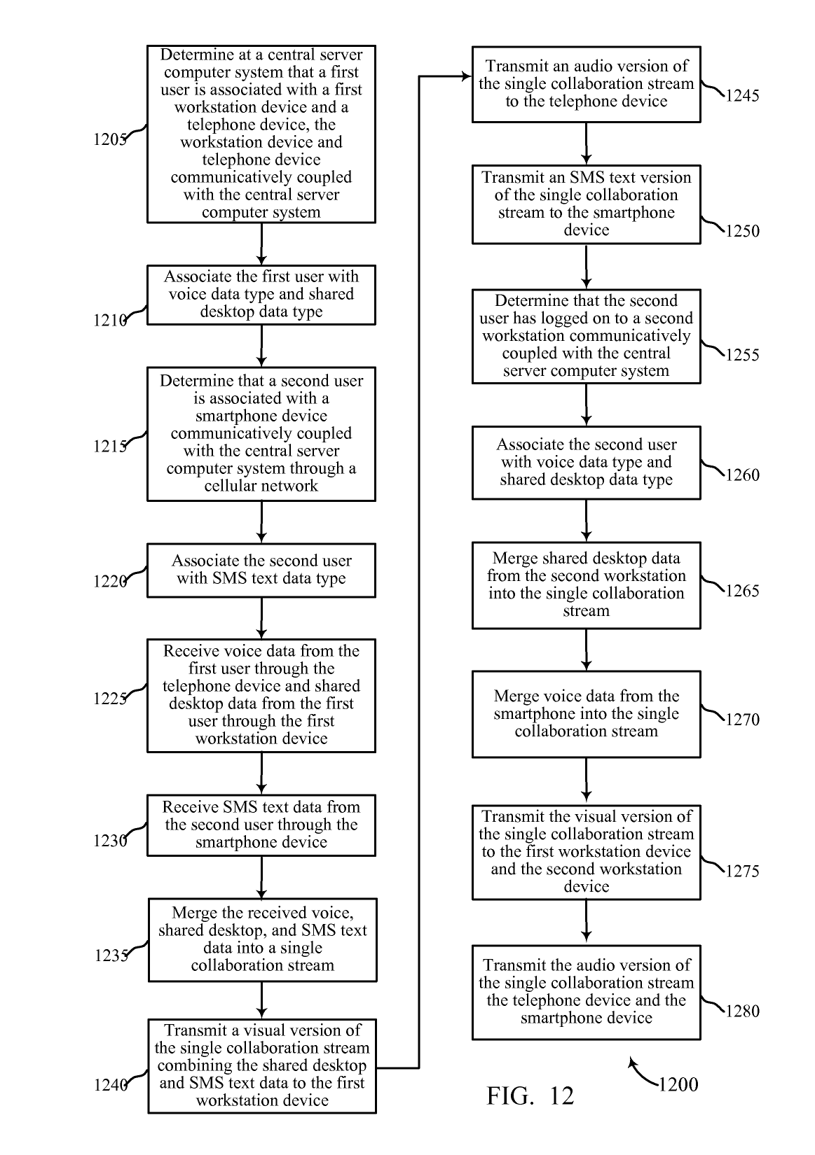

FIG. 12 illustrates a flowchart of another example method 1200 of collaboration activity coordination among multiple form factors. The method 1200 may be performed, for example, by one or more of the central server computer systems 110 or rules engines 115 described above with reference to the previous Figures.

At block 1205, it may be determined at a central server computer system that a first user is associated with a first workstation device and a telephone device, where the workstation device and telephone device are communicatively coupled with the central server computer system. At block 1210, the first user may be associated with a voice data type and a shared desktop data type. At block 1215, it may be determined that a second user is associated with a smartphone device communicatively coupled with the central server computer system through a cellular network. At block 1220, the second user may be associated with an SMS text data type.

At block 1225, voice data may be received from the first user through the telephone device, and shared desktop data may be received from the first user through the first workstation device. At block 1230, SMS text data may be received from the second user through the smartphone device. At block 1235, the received voice, shared desktop, and SMS text data may be merged into a single collaboration stream. At block 1240, a visual version of the single collaboration stream combining the shared desktop and SMS text data may be transmitted to the first workstation device. At block 1245, an audio version of the single collaboration stream may be transmitted to the telephone device. At block 1250, an SMS text version of the single collaboration stream (e.g., including text transcriptions of the voice data) may be transmitted to the smartphone device.

At block 1255, it may be determined that the second user has logged on to a second workstation communicatively coupled with the central server computer system. At block 1260, a user record may be updated to associate the second user with the voice data type and the shared desktop data type. At block 1265, shared desktop data received from the second workstation may be merged into the single collaboration stream. At block 1270, voice data received from the smartphone may be merged into the single collaboration stream. At block 1275, the visual version of the single collaboration stream may be transmitted to the first workstation device and the second workstation device. At block 1280, the audio version of the single collaboration stream may be transmitted to the telephone device and the smartphone device.

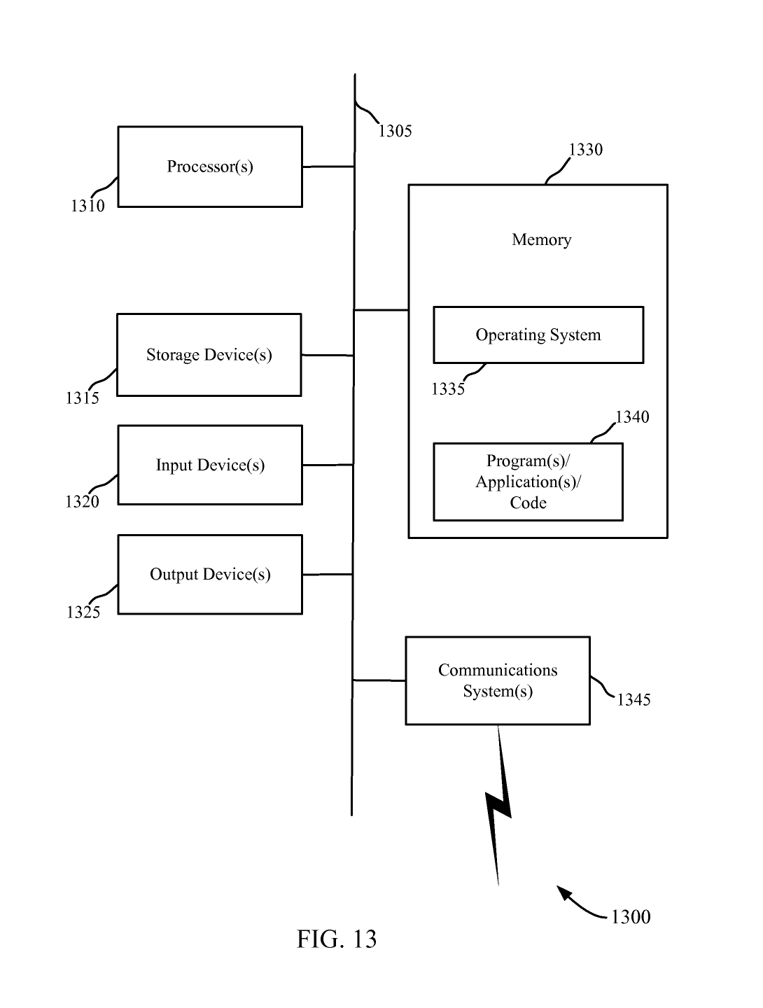

A device structure 1300 that may be used for a host device 105, a central server computer system 110, a rules engine 115, a terminal device 120, or other computing devices described herein, is illustrated with the schematic diagram of FIG. 13. This drawing broadly illustrates how individual system elements of each of the aforementioned devices may be implemented, whether in a separated or more integrated manner. The exemplary structure is shown comprised of hardware elements that are electrically coupled via bus 1305, including processor(s) 1310 (which may further comprise a DSP or special-purpose processor), storage device(s) 1315, input device(s) 1320, and output device(s) 1325. The storage device(s) 1315 may be a machine-readable storage media reader connected to any machine-readable storage medium, the combination comprehensively representing remote, local, fixed, or removable storage devices or storage media for temporarily or more permanently containing computer-readable information. The communications systems interface 1345 may interface to a wired, wireless, or other type of interfacing connection that permits data to be exchanged with other devices. The communications system(s) interface 1345 may permit data to be exchanged with a network.

The structure 1300 may also include additional software elements, shown as being currently located within working memory 1330, including an operating system 1335 and other code 1340, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of initiating collaboration activities, comprising:
receiving a trigger event for a collaboration activity at a central server computer system;
identifying a set of participants in the collaboration activity;
identifying a current device associated with each of the identified participants; and
applying a set of rules to the received trigger event and the identified participants to preemptively establish a bridge for the collaboration activity between each of the identified devices prior to a start of the collaboration activity.

2. The method of claim 1, further comprising:
notifying at least a subset of the participants of the collaboration activity after establishing the bridge for the collaboration activity.

3. The method of claim 2, further comprising:
determining a current activity of at least one participant of the set of participants;
wherein a type of notification provided to the at least one participant is based at least in part on the current activity of the at least one participant.

4. The method of claim 3, further comprising:
determining a priority associated with the current activity of the at least one participant; and
determining whether to notify the at least one participant of the collaboration activity based on the determined priority.

5. The method of claim 2, wherein the type of notification provided to the at least one participant is further based on the identified current device associated with the at least one participant.

6. The method of claim 2, further comprising:
automatically initiating participation in the collaboration activity for the at least one participant based at least in part on the current activity.

7. The method of claim 1, further comprising:
determining a location of at least one participant of the identified set of participants;
wherein the identifying the current device associated with the at least one participant is based at least in part on the determined location.

8. The method of claim 1, wherein the identifying the current device associated with each of the identified participants comprises:
maintaining a dynamically updated inventory of devices associated with each participant.

9. The method of claim 1, wherein the identifying the current set of participants comprises:
applying a set of one or more predetermined rules to the trigger event to identify the current set of participants from a pool of possible participants.

10. An apparatus for initiating collaboration activities, comprising:
at least one processor; and
a memory communicatively coupled with the at least one processor, the processor configured to execute computer-readable program code causing the at least one processor to:
receive a trigger event for a collaboration activity;
identify a set of participants in the collaboration activity;
identify a current device associated with each of the identified participants; and
apply a set of rules to the received trigger event and the identified participants to preemptively establish a bridge for the collaboration activity between each of the identified devices prior to a start of the collaboration activity.

11. The apparatus of claim 10, wherein the computer-readable program code further causes the at least one processor to:
notify at least a subset of the participants of the collaboration activity after establishing the bridge for the collaboration activity.

12. The apparatus of claim 11, wherein the computer-readable program code further causes the at least one processor to:
determine a current activity of at least one participant of the set of participants;
wherein a type of notification provided to the at least one participant is based at least in part on the current activity of the at least one participant.

13. The apparatus of claim 12, wherein the computer-readable program code further causes the at least one processor to:
determine a priority associated with the current activity of the at least one participant; and
determine whether to notify the at least one participant of the collaboration activity based on the determined priority.

14. The apparatus of claim 11, wherein the type of notification provided to the at least one participant is further based on the identified current device associated with the at least one participant.

15. The apparatus of claim 11, wherein the computer-readable program code further causes the at least one processor to:
automatically initiate participation in the collaboration activity for the at least one participant based at least in part on the current activity.

16. The apparatus of claim 10, wherein the computer-readable program code further causes the at least one processor to:
determine a location of at least one participant of the identified set of participants;
wherein the identifying the current device associated with the at least one participant is based at least in part on the determined location.

17. The apparatus of claim 10, wherein the computer-readable program code further causes the at least one processor to:
maintaining a dynamically updated inventory of devices associated with each participant.

18. The apparatus of claim 10, wherein the computer-readable program code further causes the at least one processor to:
apply a set of one or more predetermined rules to the trigger event to identify the current set of participants from a pool of possible participants.

19. A system, comprising:
a plurality of terminal devices; and
a central server computer system communicatively coupled with the plurality of terminal devices over a network, the central server computer system configured to:
receive a trigger event for a collaboration activity;
identify a set of participants in the collaboration activity;
identify a current one of the terminal devices associated with each of the identified participants; and
apply a set of rules to the received trigger event and the identified participants to preemptively establish a bridge for the collaboration activity between each of the identified terminal devices prior to a start of the collaboration activity.

20. The system of claim 19, wherein the central server computer system is further configured to:
notify at least a subset of the participants of the collaboration activity after establishing the bridge for the collaboration activity; and
determine a current activity of at least one participant of the set of participants;
wherein a type of notification provided to the at least one participant is based at least in part on the current activity of the at least one participant.
